(19) United States
(12) Patent Application Publication
(10) Pub. No.: US 2008/0002773 A1
(43) Pub. Date: Jan. 3, 2008

(54) VIDEO DECODED PICTURE BUFFER

(75) Inventor: Wai-Ming Lai, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/766,250

(22) Filed: Jun. 21, 2007

Related U.S. Application Data
(60) Provisional application No. 60/805,773, filed on Jun. 26, 2006.

(51) Int. Cl. H04N 7/12

(52) U.S. Cl. 375/240.16

(57) ABSTRACT

The H.264/AVC decoded picture buffer is managed with an additional display queue list and a free buffer list together with the decoded picture buffer determined by pointers to frame buffers to limit frame copying.

### CROSS-REFERENCE TO RELATED APPLICATIONS

This application claims priority from provisional application No. 60/805,773, filed Jun. 26, 2006.

### BACKGROUND

The present invention relates to digital video signal processing, and more particularly to devices and methods for video coding.

There are multiple applications for digital video communication and storage, and multiple international standards for video coding have been and are continuing to be developed. Low bit rate communications, such as, video telephony and conferencing, led to the H.261 standard with bit rates as multiples of 64 kbps, and the MPEG-1 standard provides picture quality comparable to that of VHS videotape. Subsequently, H.263, MPEG-2, and MPEG-4 standards have been promulgated. H.264/AVC is a recent video coding standard that makes use of several advanced video coding tools to provide better compression performance than existing video coding standards.

At the core of all of these standards is the hybrid video coding technique of block motion compensation (prediction) plus transform coding of prediction error. Block motion compensation is used to remove temporal redundancy between successive pictures (frames or fields) by prediction from prior pictures, whereas transform coding is used to reduce spatial correlations within each block of prediction errors. Further, block prediction within a picture may be used to remove spatial redundancy. FIG. 2a-2b illustrate H.264/AVC functions which include a deblocking filter within the motion compensation loop to limit artifacts created at block edges.

Traditional block motion compensation schemes basically assume that between successive pictures an object in a scene undergoes a displacement in the x- and y-directions and these displacements define the components of a motion vector. Thus an object in one picture can be predicted from the object in a prior picture by using the object's motion vector. Block motion compensation simply partitions a picture into blocks and treats each block as an object and then finds its motion vector which locates the most-similar block in a prior picture (motion estimation). This simple assumption works out in a satisfactory fashion in most cases in practice, and thus block motion compensation has become the most widely used technique for temporal redundancy removal in video coding standards. Further, periodic insertion of pictures coded without motion compensation mitigate error propagation; blocks encoded without motion compensation are called intra-coded, and blocks encoded with motion compensation are called inter-coded.

Block motion compensation methods typically decompose a picture into macroblocks where each macroblock contains four 8×8 luminance (Y) blocks plus two 8×8 chrominance (Cb and Cr or U and V) blocks, although other block sizes, such as 4×4, are also used in H.264/AVC. The residual (prediction error) block can then be encoded (i.e., block transformation, transform coefficient quantization, entropy encoding). The transform of a block converts the pixel values of a block from the spatial domain into a frequency domain for quantization; this takes advantage of decorrelation and energy compaction of transforms such as the two-dimensional discrete cosine transform (DCT) or an integer transform approximating a DCT. For example, in MPEG and H.263, 8×8 blocks of DCT-coefficients are quantized, scanned into a one-dimensional sequence, and coded by using variable length coding (VLC). H.264/AVC uses an integer approximation to a 4×4 DCT for each of sixteen 4×4 Y blocks and eight 4×4 chrominance blocks per macroblock. Thus an inter-coded block is encoded as motion vector(s) plus quantized transformed residual (prediction error) block.

Similarly, intra-coded pictures may still have spatial prediction for blocks by extrapolation from already encoded portions of the picture. Typically, pictures are encoded in raster scan order of blocks, so pixels of blocks above and to the left of a current block can be used for prediction. Again, transformation of the prediction errors for a block can remove spatial correlations and enhance coding efficiency.

The rate-control unit in FIG. 2a is responsible for generating the quantization step (qp) by adapting to a target transmission bit-rate and the output buffer-fullness; a larger quantization step implies more vanishing and/or fewer quantized transform coefficients which leads to fewer and/or shorter codewords and consequent smaller bit rates and files.

In the hypothetical reference decoder of H.264/AVC Annex C, the decoded picture buffer (DPB) contains decoded frames; see FIG. 2c. These frames are held either for future output or for use as reference frames in future decoding. Unlike preceding video codecs, H.264/AVC allows multiple reference frames and out-of-order picture encoding/decoding and is therefore no longer a “one frame in, one frame out” system. Initial delay is required for the DPB to be filled up and frames are output in bursts rather than in a constant flow. After feeding in one frame of encoded data, there could either be no output at all or up to 16 frames of output, depending on the contents of the DPB. And according to the H.264/AVC specification, the decoding process could re-use a frame's buffer once the frame data has been output and is not being used as reference. This could potentially cause loss of frame data before it gets displayed.

In a real-time application, the display of the decoded pictures must be smooth and continuous, which means getting one frame for display after each frame is decoded. To achieve this, the system must be able to handle multiple output frames, preventing them from being over-written by incoming data, while maintaining a constant display of pictures. A straight forward solution is to copy all output frame contents to a separate display buffer. The decoding process can then be continued in parallel with frame display.

However, copying large amounts of data is expensive in terms of processing time and memory bandwidth. To avoid overwriting of frame data before it is actually displayed, the display buffer must be at least as big as the DPB. This increase in memory is not desirable in commercial applications, where cost must be minimized.

### SUMMARY OF THE INVENTION

The present invention provides management of a decoded picture buffer with a list of the output frames in a display queue structure.

### BRIEF DESCRIPTION OF THE DRAWINGS

FIG. 1a-1c show buffers and operation of preferred embodiments.

FIG. 2a-2c show video encoding and decoding functional blocks.

FIG. 3a-3b illustrate a processor and packet network communication.

### DESCRIPTION OF THE PREFERRED EMBODIMENTS

### 1. Overview

Preferred embodiments are able to avoid copying frame data and minimize memory usage by maintaining a list of the output frames in a display queue (DQ) structure as part of management of a decoded picture buffer (DPB). A frame is kept in the DQ until it is sent for display by the system. While the frames are waiting in the DQ, the DPB would not have access to these frame buffers, hence eliminating the chance of frame data being over-written prior to display. To ensure normal H.264/AVC operation of the DPB and continuation of the decoding process, the preferred embodiments also keep a list of free frame buffers. The empty spots in the DPB are filled up with available free buffers. Once a frame is no longer needed for reference or display, the frame buffer is put back to the list of free frame buffers. This keeps the number of extra free buffers to a minimal three and reduces the memory usage significantly. For example, in the case of a decoder compliant to level 2 of H.264/AVC, the DPB consists of 6 frame buffers when decoding a CIF sequence, and 16 frame buffers when decoding a QCIF sequence. In the prior art memory copy solution, the number of frame buffers needs to be doubled; that is, 12 CIF frame buffers or 32 QCIF frame buffers are needed. Preferred embodiments are able to reduce the total number of frame buffers needed from 12 to 9 for CIF and from 32 to 19 for QCIF, which translates to a saving of memory usage by 25% and 40% respectively.

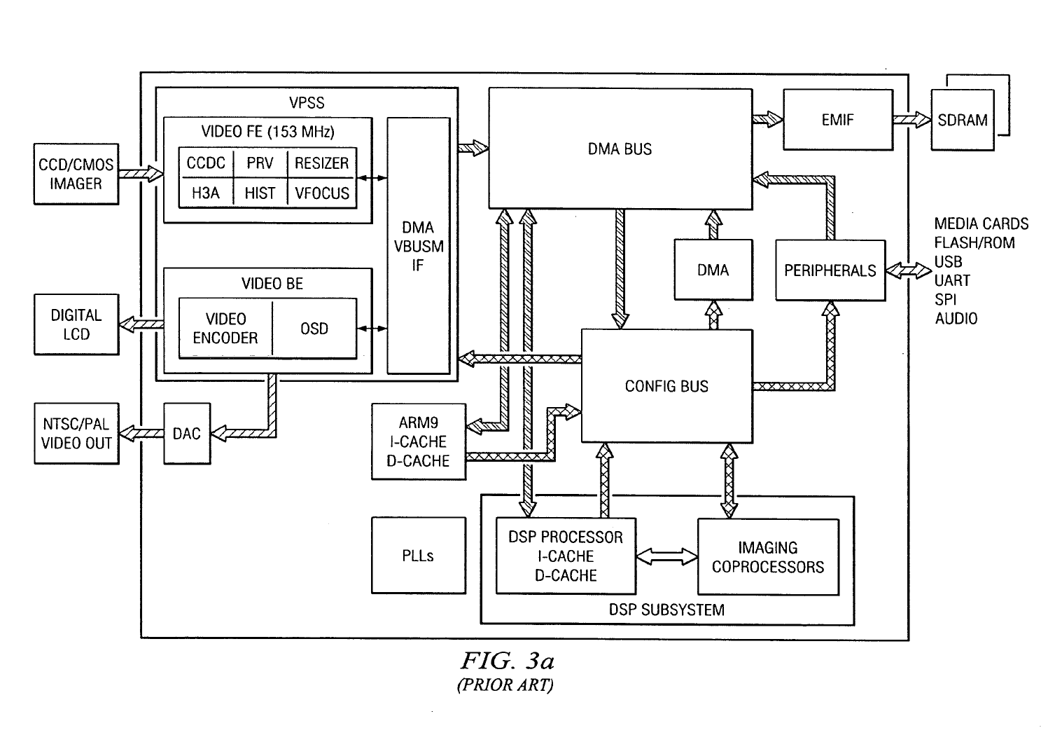

Preferred embodiment systems (e.g., camera cell-phones, PDAs, digital cameras, notebook computers, etc.) perform preferred embodiment methods with any of several types of hardware, such as digital signal processors (DSPs), general purpose programmable processors, application specific circuits, or systems on a chip (SoC) such as multicore processor arrays or combinations such as a DSP and a RISC processor together with various specialized programmable accelerators. FIG. 3a is a functional block diagram of a processor with a video back-end for display in the upper left. A stored program in an onboard or external (flash EEP) ROM or FRAM could implement the signal processing methods. Analog-to-digital and digital-to-analog converters can provide coupling to the analog world; modulators and demodulators (plus antennas for air interfaces such as for video on cell-phones) can provide coupling for transmission waveforms; and packetizers can provide formats for transmission over networks such as the Internet as illustrated in FIG. 3b.

### 2. Decoded Picture Buffer Operation

Annex C (hypothetical reference decoder) of the H.264/AVC specification describes the normal operation of the decoded picture buffer (DPB). In particular, the DPB contains frame buffers; and each of the frame buffers may contain a decoded frame, a decoded complementary field pair, or a single (non-paired) decoded field which is marked as “used for reference” or is held for future output. When a picture is decoded, it is first put in a temporary storage (currFrame). It is then either stored in the DPB or output and discarded according to the rules listed as follows (note that “IDR” is “instantaneous decoding refresh” and implies an access unit which can be decoded without reference to prior access units):

if (IDR)

if (non_ref_pic_reset_flag)

empty DPB (free_ctr = DPB size)

else

output all pictures
empty DPB (free_ctr = DPB size)

store currFrame in DPB, free_ctr−−
mark frame as “used for short-term reference” or “used for long-term
reference”

else

if ((non reference) && (picture order count is smallest))

output currFrame

else

if (picture order count is smallest)

output currFrame

if (free_ctr)

store currFrame in DPB, free_ctr−−

else

do “bumping”

output frame in DPB with smallest picture order count
if (non reference)

free_ctr++

endif

while (!free_ctr)
store currFrame in DPB, free_ctr−−

endif

endif

endif

The variable currFrame is the currently decoded frame, and free_ctr is a counter for the number of frame buffers in the DPB currently available for storing a frame. When currFrame must be stored in the DPB (i.e., currFrame is either a reference frame or is a frame to be displayed after one of the frames already stored), the decoder uses bumping to insure at least one frame buffer is free. The bumping (“do . . . while (!free_ctr)”) proceeds through the DPB stored frames in order of first to be output (for display) until free_ctr is positive. Note that output of a non-reference frame increments free_ctr because its frame buffer is now free; whereas, output of a reference frame does not free its frame buffer because the frame is still needed as a reference.

An example will illustrate the problem of multiple reference frames and out-of-order display. Presume DPB has 6 frame buffers, labeled FBa, FBb, FBc, FBd, FBe, and FBf; and presume frames F1, F2, F3, . . . each uses all six prior frames as references but that the display order of the frames is F1, F4, F5, F6, F3, F7, F2, F8, F9 . . . (this assumes F3 references prior displayed F1 and future displayed F2). Then with DPB containing reference frames F1 in FBa, F2 in FBb, F3 in FBc, F4 in FBd, F5 in FBe, and F6 in FBf, when F7 is decoded, F1 is changed to non-reference and FBa is free (F1 had previously been output because it had the smallest picture order count), and F7 is stored in FBa. When F8 is decoded, F2 is changed to non-reference, but F2 had not been previously output because of its late display order, so FBb is not free. Then bumping first outputs F4; however, F4 is still a reference (for F9-F10), so FBd is not freed. Next, bumping outputs F5; however F5 is still a reference (for F9-F11), so FBe is not free. Similarly, bumping outputs F6 without freeing FBf, outputs F3 without freeing FBc, and outputs F7 without freeing FBa. Finally, bumping outputs F2 and frees FBb for storage of F8. Now F2 has been output, but it is not to be displayed until F4, F5, F6, F3, and F7 have been displayed, which is 5 frames from now. Consequently, if we store F8 in the same physical buffer FBb, F2 may be lost without additional frame buffers.

### 3. Display Queue Preferred Embodiment

In order to remain compliant to H.264/AVC as described in the preceding section, the introduction of a preferred embodiment display queue (DQ) must leave the status of the DPB unchanged. The number of frame buffers in DPB must be kept constant all through the decoding process, and a non-reference frame must become “free” after it is output. To achieve this, we keep a list of extra free frame buffers. When the DPB needs to output a frame, this frame is put in the DQ. If the frame is a reference frame, it stays in the DPB and is labeled as “is output”. If the frame is non-reference, the spot in the DPB will be replaced with a free frame buffer and it will be labeled as “free” in the DPB. The free_ctr can then be incremented the same way as shown by “free_ctr++” in preceding section 2. When the system requests a frame for display, one frame is retrieved from DQ and placed in the system display buffer. This frame is assumed to have been actually displayed when we receive the next request from the system for a frame to display. If it is a reference frame, it will be labeled as “is displayed” in the DPB. Otherwise, the frame buffer will be added back to the free frame buffer list to be re-used.

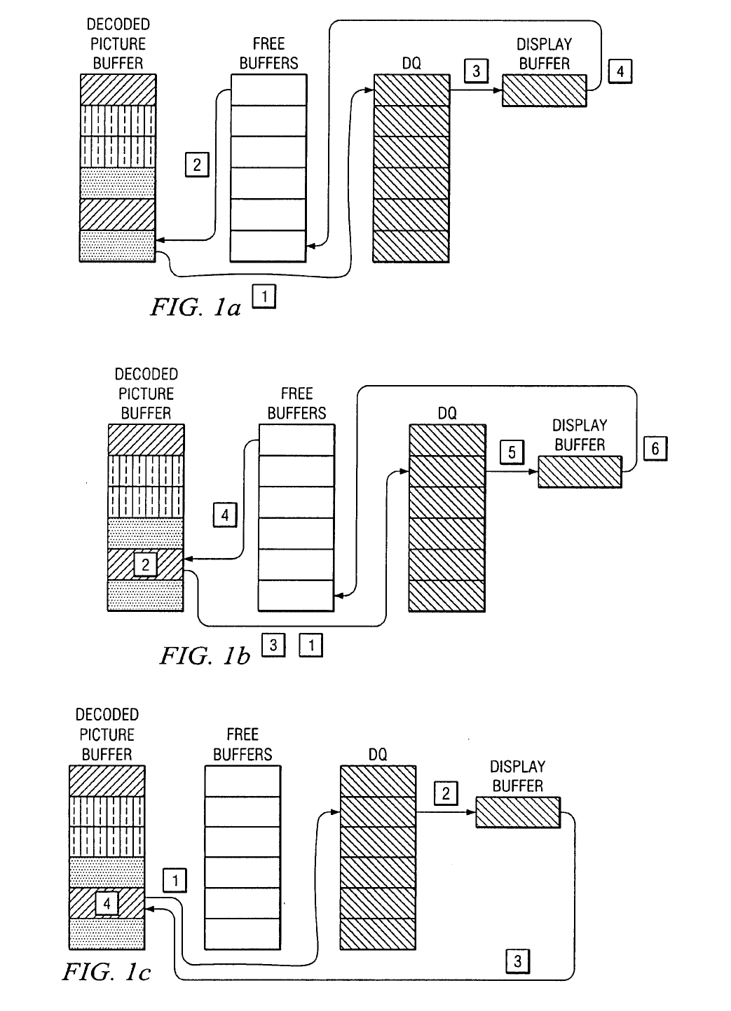

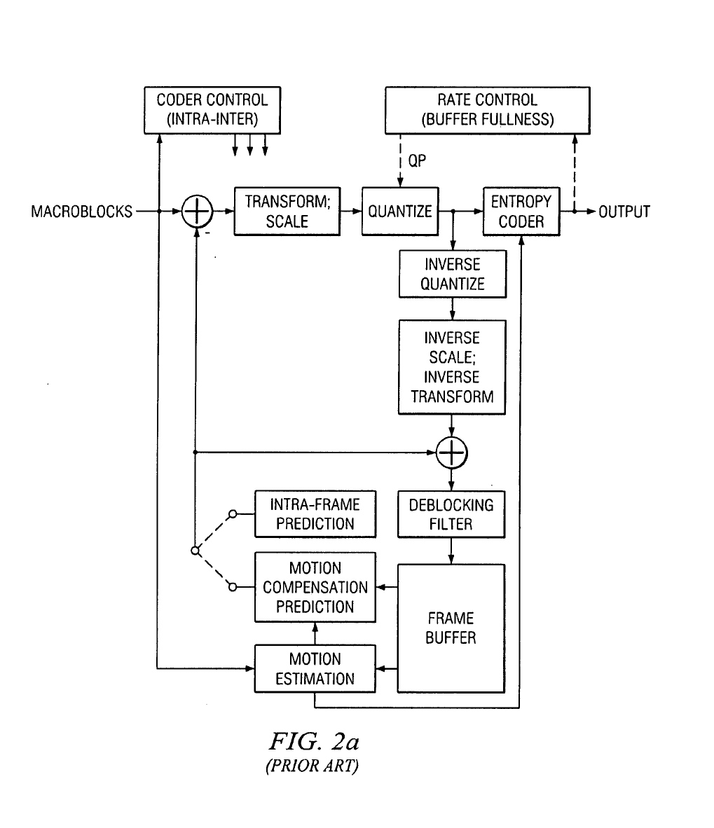

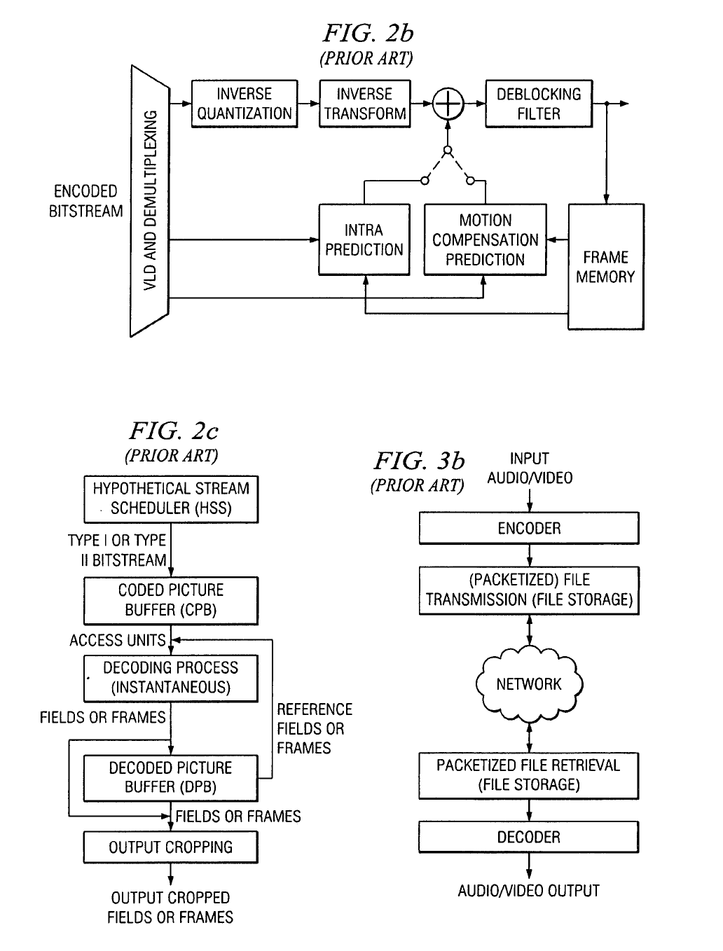

The sequence of operations of the DPB and DQ for a non-reference frame can be summarized as follows and as illustrated in FIG. 1a:

Step 1

DPB puts non-reference frame in the DQ.

Step 2

The frame buffer in DPB is replaced by a free buffer.

Step 3

Upon request from the system, the frame is sent from DQ to the system display buffer for display.

Step 4

When the next request is received from system, the displayed frame is put back to the free buffer list to be re-used, and the next entry in the DQ is sent to the display buffer.

The operation sequence is different when the frame is either a short-term or a long-term reference frame. The frame must remain in the DPB until it changes its status to a non-reference frame. If it is still in the DQ when it becomes non-reference, it means that it is still waiting to be displayed. The DQ management is informed of the status change and the frame buffer in DPB is replaced by a free buffer. The frame in the DQ will then be treated the same way as a non-reference frame and when it is displayed, it will be put back to the free buffer list. If the frame has been displayed when it changes status, the contents of the frame buffer do not need to be preserved. The same buffer can be labeled as “free” and can be re-used right away.

FIG. 1b-1c show the following first and second scenarios, respectively.

Scenario 1:

Step 1

DPB puts reference frame in the DQ.

Step 2

The reference frame changes to non-reference frame.

Step 3

DPB informs DQ that the frame has changed to non-reference frame.

Step 4

The frame buffer in DPB is replaced by a free buffer.

Step 5

Upon a request from the system, the frame is sent to the system display buffer for display.

Step 6

When the next request from the system is received, the displayed frame is put back to the free buffer list to be re-used, and the next entry in the DQ is sent to the display buffer.

Scenario 2:

Step 1

DPB puts reference frame in the DQ.

Step 2

Upon a request from the system, a frame is sent to the system display buffer for display.

Step 3

When the next request from the system is received, DQ informs DPB that the frame has been displayed.

Step 4

The reference frame changes to a non-reference frame. The frame buffer in DPB becomes a free buffer.

The preferred embodiments only need three frame buffers in addition to the number needed for DPB because one is used for decoding the current frame (currFrame), one is used as the free buffer to replace the “freed” but not yet displayed buffer in the DPB, and one is for the display buffer. Since we use address pointers in DPB and DQ, the placement of buffers is achieved by moving pointers to frame buffers, and no memory copy is required.

### 4. Modifications

The preferred embodiments may be modified in various ways while retaining one or more of the features of a display queue.

For example, the frames could be replaced by fields with storage of complementary fields in a single buffer, the number of permissible reference frames could be varied, and so forth.

What is claimed is:

1. A method of decoding of video having motion compensation with multiple reference pictures, comprising the steps of:
(a) providing a plurality of frame buffers;
(b) providing a decoded picture buffer (DPB) as a subplurality of said plurality of frame buffers, where reference frames needed for decoding are kept in said DPB;
(c) providing a display queue list (DQ) of output frames of said DPB, where a frame is kept in said DQ until it is sent for display and where a frame in said DQ prevents said DPB access to the corresponding frame buffer;
(d) providing a list of free frame buffers, where a frame buffer with a frame which is no longer needed for reference or display is put in the list of free frame buffers and is available for said DPB;
(e) decoding an input frame; and
(f) when said decoded input frame is a reference frame, storing said decoded input frame in said DPB, where after said DPB outputs a frame to said DQ, said DQ and said free frame buffer list are updated; and
(g) repeating steps (e)-(f) with said input frame replaced by subsequent frames.

2. The method of claim 1, wherein when a frame output from said DPB to said DQ is a non-reference frame, the corresponding frame buffer in said DPB is replaced by a free frame buffer.

3. The method of claim 1, wherein when a frame output from said DPB to said DQ is a reference frame and when said a frame changes from a reference frame to a non-reference frame prior to display, the corresponding frame buffer in said DPB is replaced by a free frame buffer.

4. The method of claim 1, wherein when a frame output from said DPB to said DQ is a reference frame and when said a frame changes from a reference frame to a non-reference frame after display, the corresponding frame buffer in said DPB becomes a free frame buffer.

5. A decoder for decoding video having motion compensation with multiple reference pictures, comprising:
(a) N+3 frame buffers where N is the number of references frames for a decoded picture buffer (DPB);
(b) a processor coupled to said frame buffers, said processor operable to:
(i) store a reference frame needed for decoding in said DPB;
(ii) provide a display queue list (DQ) of output frames of said DPB, where a frame is kept in said DQ until it is sent for display and where a frame in said DQ prevents said DPB access to the corresponding frame buffer;
(iii) provide a list of free frame buffers, where a frame buffer with a frame which is no longer a reference frame or needed for display is put in the list of free frame buffers and is available for said DPB;
(iv) decode an input frame using one of said frame buffers and said DPB; and
(v) when said decoded input frame is to be stored in said DPB, update said DPB output frames in said DQ and said free frame buffer list;
(c) wherein said DPB is determined by N pointers to N of said N+3 frame buffers.
